(19) United States
(12) Patent Application Publication
(10) Pub. No.: US 2025/0187925 A1
(43) Pub. Date: Jun. 12, 2025

(54) METHOD TO PRODUCE SYNTHETIC GRAPHITE

(71) Applicant: The Johns Hopkins University, Baltimore, MD (US)

(72) Inventors: Jonah D. Erlebacher, Chevy Chase, MD (US); Jonathan Luke Horlyck, Washington, DC (US); Shashank Vummidi Lakshman, Columbia, MD (US); Gina Greenidge, Baltimore, MD (US); Anna Goodridge, Columbia, MD (US); Ellen Benn, Columbia, MD (US)

(21) Appl. No.: 18/978,730

(22) Filed: Dec. 12, 2024

Related U.S. Application Data
(60) Provisional application No. 63/609,148, filed on Dec. 12, 2023.

(51) Int. Cl. C01B 32/205; H01M 4/587; H01M 10/0525

(52) U.S. Cl. CPC C01B 32/205; H01M 4/587; H01M 10/0525; C01P 2002/82; C01P 2004/04; C01P 2006/40; C01P 2006/80

(57) ABSTRACT

Producing an ordered graphitic carbon includes contacting a material including disordered elemental carbon and a metal with chlorine gas, thereby yielding a gaseous product comprising a chloride of the metal and a solid product comprising the ordered graphitic carbon.

### CROSS-REFERENCE TO RELATED APPLICATION

This application claims the benefit of U.S. patent application Ser. No. 63/609,148 filed on Dec. 12, 2023, which is incorporated by reference herein in its entirety.

### FEDERALLY SPONSORED RESEARCH OR DEVELOPMENT

This invention was made with Government support under cooperative agreement no. DE-AR0001019, awarded by the Department of Energy. The Government has certain rights in the invention.

### TECHNICAL FIELD

The presently disclosed subject matter provides a process to produce synthetic graphite from natural gas. The synthetic graphite is suitable for use as electrodes in lithium ion batteries.

### BACKGROUND

Graphite is a layered mineral comprised of pure carbon comprised of sheets of sp²-hybridized carbon (“graphene sheets”) bound together by weak van der Waals forces. There are two primary kinds of graphite: natural graphite (NG) is found in mineral deposits of varying purity across the world, and conventional synthetic graphite (SG) is produced from petroleum coke. Both forms of graphite typically require extensive processing before they are suitable for any applications, for instance, as anodes for lithium ion batteries. Processing of NG typically requires extraction of high-grade graphite from ore (beneficiation) and purification. Processing of conventional SG typically requires calcination of petroleum coke followed by high temperature (T>2000° C.) carbonization and graphitization. In both cases, life-cycle emissions of carbon dioxide or carbon dioxide equivalent emissions are substantial, and the energy inputs to process these materials are high. Using the GREET database maintained by Argonne National Laboratories, processing of natural graphite is estimated to lead to over 800 kg of CO₂-e (carbon-dioxide equivalent) emissions (GHG-20) and over 7,500 MJ of energy per metric ton processed; processing of synthetic graphite, is estimated to lead to GHG-20 emissions of 18.9 metric tons of CO₂-e per metric ton of material, with an energy input over 100,000 MJ per metric ton processed.

### SUMMARY

This disclosure describes a method to produce synthetic graphite using natural gas as a source of carbon. The method results in significantly lower emissions than either natural graphite (NG) or conventional synthetic graphite (SG) produced from petroleum coke, and with a lower energy input. Synthetic graphite (e.g., ordered graphitic carbon) formed as described herein may be used in a variety of applications, including anodes for lithium ion batteries.

More specifically, this disclosure generally relates to processes for removing metal from material including metal and carbon (“metal-carbon material” or “material”). In some cases, the metal-carbon material is a mixture of metal and disordered elemental carbon formed during the course of methane decomposition. In certain cases, the metal-carbon material is a mixture of metal and carbon in which the carbon encapsulates some of the metal. When these mixtures of carbon are exposed to atmospheres of hydrogen chloride (HCl) or chlorine gas at temperatures near to or above the boiling point of the metal chloride, the metal in the mixture reacts with the hydrogen chloride or chlorine to form a gaseous metal chloride. The gaseous metal chloride expands the carbon in which it was encapsulated, and also intercalates out of the material through the carbon. Together, these effects lead to a significant improvement in the graphitic quality of the carbon, as well as simultaneously purification of the material.

In an embodiment of this process, a nickel-carbon powder mixture formed by methane pyrolysis is exposed to an atmosphere of flowing HCl at an elevated temperature (e.g., 1100° C.). As chlorine gas flows through the mixture, chlorine reacts with the nickel in the powder mixture, including nickel exposed to the atmosphere as well as nickel protected by carbon shells. The reaction product is nickel chloride, which sublimes and flows away until it reaches a colder area and condenses. Suitable metals for this process include nickel, iron, manganese, cobalt, zinc, and magnesium, as well as combinations of two or more of these metals. Carbon formed by this method can be at least 99.99% pure; the metals content is typically found to be less than 100 ppm.

Certain aspects of the presently disclosed subject matter having been stated hereinabove, which are addressed in whole or in part by the presently disclosed subject matter, other aspects will become evident as the description proceeds when taken in connection with the accompanying Example and Figures as best described herein below.

### BRIEF DESCRIPTION OF DRAWINGS

FIG. 1 shows a transmission electron micrograph of disordered carbon-encapsulated nickel particles formed by methane pyrolysis.

FIG. 2 shows a Raman spectrum of disordered carbon-encapsulated nickel particles formed by methane pyrolysis.

FIG. 3 shows a transmission electron micrograph of synthetic graphite formed after exposing carbon-encapsulated nickel particles to hydrogen chloride at 1000° C.

FIG. 4 shows a high magnification transmission electron micrograph of synthetic graphite showing graphene sheets of the synthetic graphite.

FIG. 5 shows a Raman spectrum of synthetic graphite formed by removal of metal from disordered carbon-encapsulated particles.

FIG. 6 is a plot showing capacity of synthetic graphite vs. cycle number under C/10 cycling protocols.

FIG. 7A depicts a lithium-ion battery. FIG. 7B depicts a device including a lithium ion battery.

### DETAILED DESCRIPTION

Provided herein are methods of removing metal from material including metal and carbon (“metal-carbon material”) under conditions where the crystalline matrix of the carbon reorganizes to form synthetic graphite (e.g., ordered graphitic carbon). The methods include: contacting the metal-carbon material with hydrogen chloride or chlorine gas, thereby yielding a metal chloride in the gas phase and a solid product comprising carbon. In some embodiments, contacting the metal-carbon material with hydrogen chloride occurs in a reactor (e.g., a tube reactor). In some embodiments, the metal-carbon material is provided on a substrate. The substrate can be any of a variety of materials suitable for supporting the metal-carbon material, and upon which the metal-carbon material can be contacted with hydrogen chloride.

The metal-carbon material disclosed herein can be particles of metal encapsulated by carbon, including disordered elemental carbon. As used herein, “encapsulated” generally refers to at least partially covered by. That is, particles of metal encapsulated by carbon generally have a metal core that is at least partially covered by a layer of carbon, completely covered by a layer of carbon, or a combination of both. As used herein “disordered elemental carbon” generally refers to defected graphite, which includes graphite with vacancy defects, interstitial defects, topological defects, or any combination thereof. In some embodiments, the metal-carbon material is coked metal-carbon material. In one example, the metal-carbon material is a degraded metal catalyst (e.g., from a hydroprocessing reaction), that is coated (e.g., encapsulated) with carbon (e.g., a coked metal-carbon material, wherein the coke is a carbonaceous or hydrocarbonaceous deposit on the metal). In some embodiments, the coked metal-carbon material is formed in a hydroprocessing reaction catalyzed by the metal. In some embodiments, the coked metal-carbon material is formed during synthesis of carbon particles catalyzed by the metal. The carbon particles typically have an average diameter in a range of about 100 nm to about 50 microns. In some cases, the carbon particles are in the form of carbon nanotubes or carbon aerosols. As used herein, the term “hydroprocessing” generally refers to a variety of catalytic processes including hydrotreating and hydrocracking for the removal of, for example, sulfur, oxygen, nitrogen, and metals, from hydrocarbon products (e.g., oil).

The method disclosed herein can include heating the metal-carbon material to a temperature that is greater than or equal to a boiling point of the metal chloride. In some embodiments, the temperature of the hydrogen chloride and the metal-carbon material after contacting is greater than or equal to a boiling point of the metal chloride. In some embodiments, the temperature of the hydrogen chloride and the metal-carbon material after contacting is at least about 300° C., at least 700° C., at least 900° C., at least about 1000° C., or at least about 1200° C. In some embodiments, the temperature of the hydrogen chloride and the metal-carbon material after contacting is about 700° C. to about 2000° C., about 1000° C. to about 1750° C., or about 1000° C. to about 1600° C. In one example, when the metal of the metal-carbon material is nickel and the metal chloride includes Ni(II)Cl₂, the temperature of the hydrogen chloride and the metal-carbon material after contacting is greater than or equal to about 975° C. (the boiling point of Ni(II)Cl₂). In some embodiments, the temperature of the hydrogen chloride is at least about 1000° C.

The method disclosed herein can include condensing the metal chloride by reducing a temperature of the metal chloride to a temperature lower than a boiling point of the metal chloride. In some embodiments, the metal chloride is condensed to a solid or a liquid. In some embodiments, the temperature of the metal chloride is lowered to less than about 700° C., less than about 500° C., less than about 100° C., or less than about 50° C.

The carbon of the solid product can include, consist essentially of, or consist of elemental carbon. The solid product can include less than 3 wt %, less than 2 wt %, less than 1 wt %, or less than 0.1 wt % of the metal. In some embodiments, the concentration of metal in the solid product is less than 1 wt %. In some embodiments, the solid product is substantially free of metal. As used herein, the term “substantially free of” an ingredient(s) as provided in the disclosure is intended to mean that the composition or compound(s) contain less than about 0.1 wt % (percent by weight of the total weight of the composition or compound(s)), or insignificant or negligible amounts of said ingredient(s) unless specifically indicated otherwise.

The carbon of the solid product can exhibit high crystallinity as measured by Raman spectroscopy.

The metal of the methods disclosed herein can include nickel, iron, manganese, cobalt, zinc, vanadium, molybdenum, magnesium, aluminum, tungsten, or an alloy or compound thereof. In some embodiments, the metal includes nickel, iron, manganese, cobalt, zinc, magnesium, or an alloy or compound thereof. In some embodiments, the metal includes nickel. In some embodiments, the metal includes iron. In some embodiments, the metal includes manganese. In some embodiments, the metal includes magnesium. In some embodiments, the metal includes cobalt. In some embodiments, the metal includes zinc.

The hydrogen chloride or chlorine of the method disclosed herein can be in a gaseous state. In some embodiments, contacting the metal-carbon material with the hydrogen chloride or chlorine comprises flowing the hydrogen chloride or chlorine over or through the metal-carbon material.

The presently disclosed subject matter now will be described more fully with reference to the accompanying Figures, in which some, but not all embodiments of the presently disclosed subject matter are shown. The presently disclosed subject matter may be embodied in many different forms and should not be construed as limited to the embodiments set forth herein. Indeed, many modifications and other embodiments of the presently disclosed subject matter set forth herein will come to mind to one skilled in the art to which the presently disclosed subject matter pertains having the benefit of the teachings presented in the foregoing descriptions and the associated Figures. Therefore, it is to be understood that the presently disclosed subject matter is not to be limited to the specific embodiments disclosed and that modifications and other embodiments are intended to be included within the scope of the appended claims.

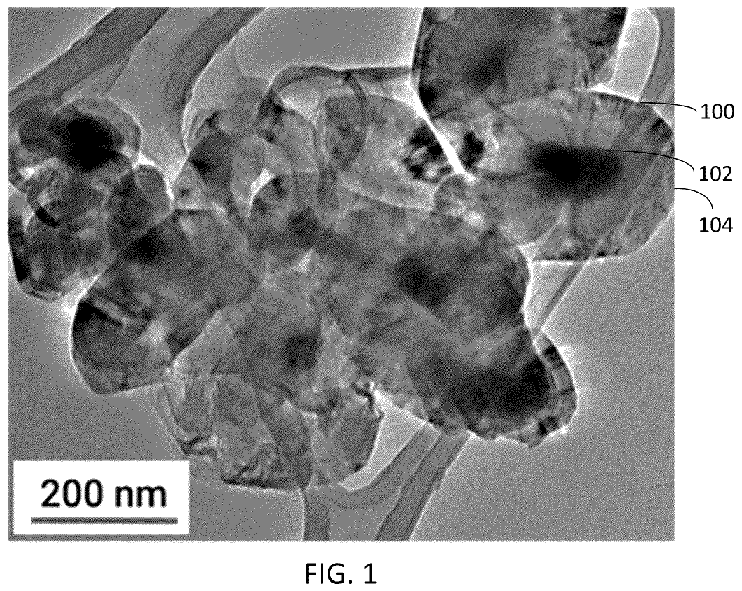

FIG. 1 shows a transmission electron micrograph of disordered-carbon-encapsulated nickel particles 100. Such particles can be formed by different chemical processes in which a nickel particle pyrolyzes the decomposition of a hydrocarbon into its constituent elements of hydrogen and carbon. In the particular material shown in FIG. 1, the material was formed by methane pyrolysis, i.e., the chemical reaction to produce hydrogen via Reaction (1):

CH₄→C+2H₂ (1)

which is catalyzed by nickel, iron, cobalt, or manganese, as well as alloys and chemical compounds comprising these elements. The activity of catalysts for this reaction tend to degrade over time, requiring the catalyst to be recycled. Other forms of metal particles encapsulated include, for example, metal particle catalysts used to synthesize carbon nanotubes. In the synthesis of carbon nanotubes, however, the same problem is encountered as with methane pyrolysis, namely, metal particles eventually become encapsulated with carbon and stop working efficiently as catalysts. In this example, the carbon is disordered at the atomic level.

As described herein, flowing hydrogen chloride gas over a mixture of spent metal catalyst leads to separation of the metal from the carbon via the formation of a volatile metal chloride. It is believed that process involves intercalation of hydrogen chloride through the carbon, formation of gaseous metal chloride that exerts an outward pressure on the carbon, de-intercalation of the metal chloride out of the metal-carbon material, followed by sublimation of the metal chloride. As such, this process can be used to remove metal that forms a chloride that also is a graphite intercalation compound. Metals in this category include nickel, iron, manganese, and cobalt. During this process, the combined effect of intercalation and gaseous pressure combine to heal defects in the carbon producing a synthetic graphite. Defected carbon (e.g., disordered elemental carbon) without encapsulated metal is typically brought to temperatures above 2000° C. for extended periods of time to heal defects in the carbon structure.

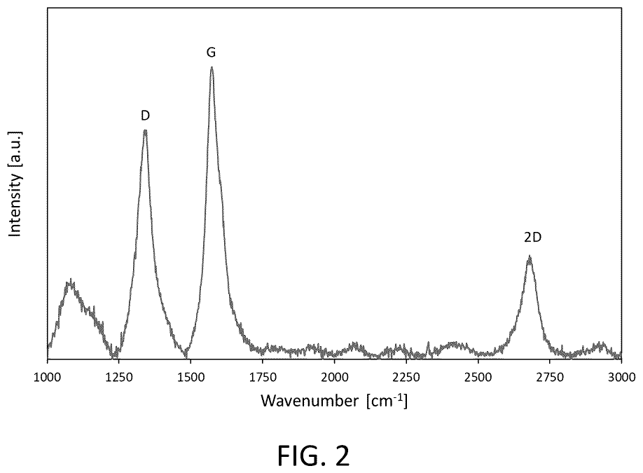

FIG. 2 shows a Raman spectrum of a sample of the material shown in FIG. 1. Raman spectroscopy is sensitive to the ordering within graphite in a sample. Undefected graphite exhibits a peak at approximately 2700 cm⁻¹ and a peak at approximately 1600 cm⁻¹; the latter peak is referred to as the “G” peak. Defected graphite causes a peak at 1325 cm⁻¹, known as the “D” peak, and impurities such as metal cores create peaks at wavenumbers below 1250 cm⁻¹. The intensity ratio D/G, a ratio of the respective peak heights, provides a measure of the crystalline quality of the material. Disordered element carbon, or defected graphite, typically has a D/G ratio in a range of about 0.75 to about 2. In one example, prior to treatment with hydrogen chloride, the D/G ratio of a metal-carbon material with a disordered elemental carbon and metal is approximately unity, there is also a peak associated with retained metal. Ordered graphitic carbon, or the synthetic graphite described herein, has fewer defects, and thus a smaller D/G ratio (e.g., in a range of about 0.05 to 0.5).

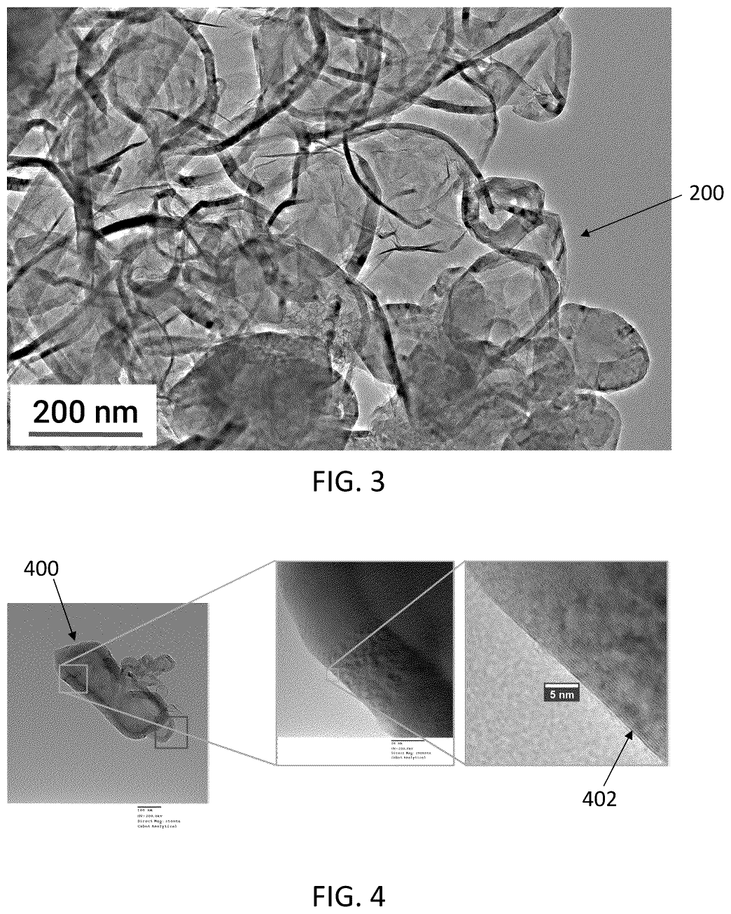

FIG. 3 shows a transmission electron micrograph of synthetic graphite 200 formed from the material shown in FIG. 1 via the method described herein.

FIG. 4 shows a high magnification transmission electron micrograph of synthetic graphite 200 showing the ordered layers of graphene sheets within the material.

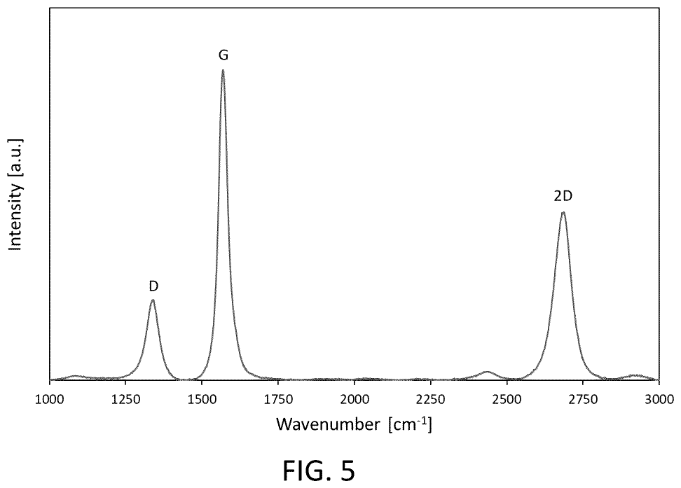

FIG. 5 shows a Raman spectrum of synthetic graphite formed by removal of metal from disordered carbon-encapsulated particles. It can be seen that removal of the metal from the sample eliminates the peak associated with impurities, and significantly reduces the D/G ratio, indicating a highly crystalline graphite.

Similar observations are made on samples prepared using chlorine gas instead of hydrogen chloride.

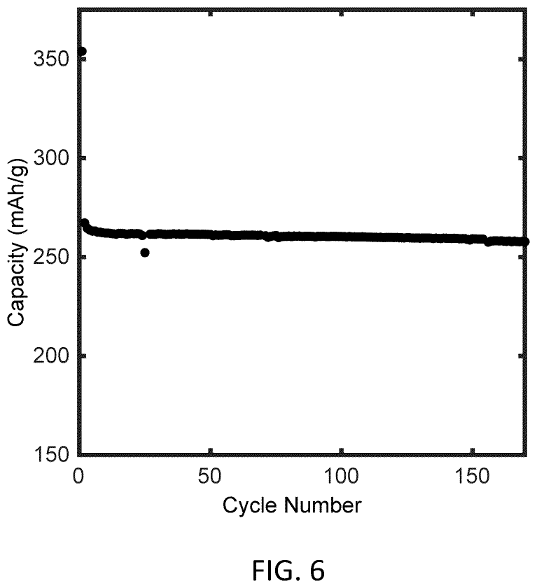

To demonstrate the utility of the synthetic graphite produced herein, synthetic graphite 200 was used as an anode for a lithium ion battery in a stainless steel coin cell. A common coin-cell configuration was used using Li metal foil with stainless steel spacer current collector as a counter/reference electrode, 1 M LiPF6 in 1:1 ethylene carbonate/dimethylene carbonate (EC/DMC) as the electrolyte, and a Celgard 2023 separator. A C/10 cycling protocol was employed (10-hour charge/10-hour discharge cycles). FIG. 6 shows the capacity and Faradaic efficiency of the cell over the course of 175 cycles. It is apparent that the capacity was approximately 260 mAh/g, and there was <5% capacity fade over the course of the measurement. It can be expected that post-processing the synthetic graphite described herein to spheronize and coat it—post-processing typically used with NG or SG—will improve battery capacity and reduce capacity fade.

Processes for forming the disordered carbon-metal precursor as described herein do not generate carbon dioxide emissions, and the reaction of metal with chlorine is exothermic. As such, processes described herein are more energy efficient than both conventional SG (e.g., produced from petroleum coke) and NG, with lower life-cycle emissions compared to conventional SG. GHG-20 emissions of 2.5 metric tons of CO₂-e per metric ton of material are estimated for this process, with an energy input of less than 7,500 MJ per metric ton processed.

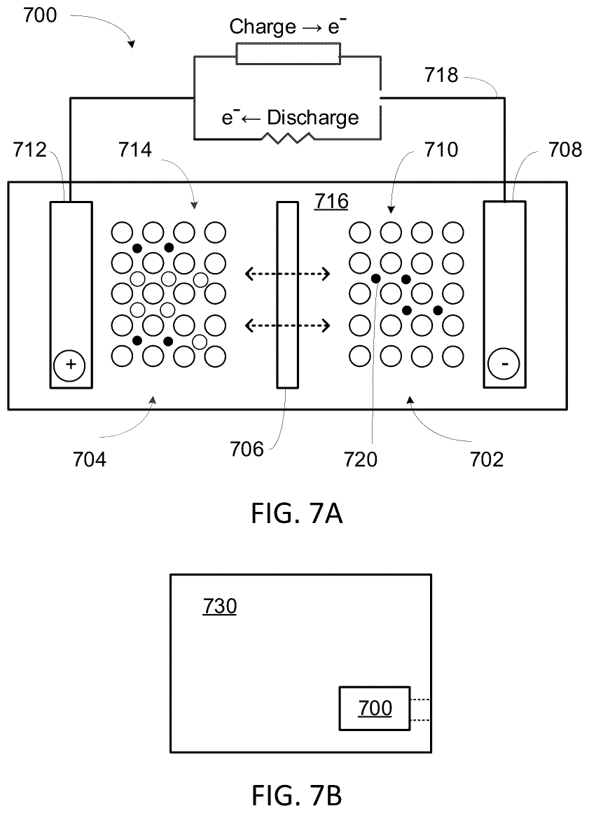

In some cases, the synthetic graphite or ordered synthetic carbon prepared as described herein can be used as (or in) an electrode (e.g., an anode or a cathode) in a lithium ion battery. An example of a lithium ion battery is depicted in FIG. 7A. FIG. 7A depicts lithium-ion battery (LIB) 700 having anode 702 and cathode 704. Anode 702 and cathode 704 are separated by separator 706. Anode 702 includes anode collector 708 and anode material 710 in contact with the anode collector. Cathode 704 includes cathode collector 712 and cathode material 714 in contact with the cathode collector. Electrolyte 716 is in contact with anode material 710 and cathode material 714. In one example, anode material 710 includes the synthetic graphite or ordered synthetic carbon prepared as described herein. Anode collector 708 and cathode collector 712 are electrically coupled via closed external circuit 718. Anode material 710 and cathode material 714 are materials into which, and from which, lithium ions 720 can migrate. During insertion (or intercalation) lithium ions move into the electrode (anode or cathode) material. During extraction (or deintercalation), the reverse process, lithium ions move out of the electrode (anode or cathode) material. When a LIB is discharging, lithium ions are extracted from the anode material and inserted into the cathode material. When the cell is charging, lithium ions are extracted from the cathode material and inserted into the anode material. The arrows in FIG. 7A depict movement of lithium ions through separator 706 during charging and discharging. FIG. 7B depicts device 730 including LIB 700. Device 730 may be, for example, an electric vehicle, an electronic device (e.g., a portable electronic device such as a cellular telephone, a tablet or laptop computer, etc.), or the like.

### EXAMPLE

The following Example is included to provide guidance to one of ordinary skill in the art for practicing implementations of the presently disclosed subject matter. In light of the present disclosure and the general level of skill in the art, those of skill can appreciate that the following Example is intended to be exemplary only and that numerous changes, modifications, and alterations can be employed without departing from the scope of the presently disclosed subject matter. The synthetic descriptions and specific examples that follow are only intended for the purposes of illustration, and are not to be construed as limiting in any manner to make compounds of the disclosure by other methods.

Samples of nickel-carbon powder containing ˜10 atomic % nickel were placed in a tube furnace and HCl was flowed through it at 1200° C. for periods of time from 30 min to 2 hours. After the time period was complete, the reactor was cooled and purged with argon. Nickel chloride sublimate condensed on the tube outside of the hot zone. After collecting the carbon, electron dispersive spectroscopy showed that the carbon powder had no detectable metal content. Elemental analysis showed the content of Ni to be less than 100 ppm by weight. Similar levels of elemental Ni were found for samples treated with flowing Cl₂ at temperatures from 1000° C. to 1200° C.

### Other Embodiments

Although the disclosed inventive concepts include those defined in the attached claims, it should be understood that the inventive concepts can also be defined in accordance with the following embodiments.

In addition to the embodiments of the attached claims and the embodiments described above, the following numbered embodiments are also innovative.

Embodiment 1 is a method of producing ordered graphitic carbon, the method comprising:
contacting a material comprising disordered elemental carbon and a metal with chlorine gas, thereby yielding:
   a gaseous product comprising a chloride of the metal; and
   a solid product comprising ordered graphitic carbon.

Embodiment 2 is the method of embodiment 1, wherein the material comprises particles of the metal encapsulated by the disordered elemental carbon.

Embodiment 3 is the method of embodiments 1 or 2, wherein the material is coked metal-carbon material.

Embodiment 4 is the method of embodiment 3, wherein the coked metal-carbon material is formed in a hydroprocessing reaction catalyzed by the metal.

Embodiment 5 is the method of embodiments 3 or 4, wherein the coked metal-carbon material is formed during synthesis of carbon particles catalyzed by the metal.

Embodiment 6 is the method of embodiment 5, wherein the coked metal-carbon material comprises particles having an average diameter in a range of about 100 nm to about 50 microns.

Embodiment 7 is the method of embodiment 6, wherein the particles are in the form of a carbon aerosol.

Embodiment 8 method of embodiments 6 or 7, wherein the particles comprise carbon nanotubes.

Embodiment 9 is the method of any one of embodiments 1-8, wherein the material comprises hydrocarbonaceous material.

Embodiment 10 is the method of any one of embodiments 1-9, wherein a temperature of the hydrogen chloride or chlorine gas and the material after contacting is greater than or equal to a boiling point of the metal chloride.

Embodiment 11 is the method of any one of embodiments 1-10, further comprising condensing the metal chloride by reducing a temperature of the metal chloride to a temperature lower than a boiling point of the metal chloride.

Embodiment 12 is the method of any one of embodiments 1-11, wherein a concentration of metal in the solid product is less than 1 wt %.

Embodiment 13 is the method of any one of embodiments 1-12, wherein the metal comprises nickel, iron, manganese, cobalt, zinc, vanadium, molybdenum, magnesium, aluminum, tungsten, or an alloy or compound thereof.

Embodiment 14 is the method of any one of embodiments 1-13, wherein the hydrogen chloride or chlorine is in the gaseous state.

Embodiment 15 is the method of embodiment 14, wherein contacting the material with the hydrogen chloride or chlorine comprises flowing the hydrogen chloride or chlorine over the material or through the material.

Embodiment 16 is the method of any one of embodiments 1-15, wherein a temperature of the hydrogen chloride or chlorine is at least about 900° C.

Embodiment 17 is the method of any one of embodiments 1-16, wherein contacting the material with the hydrogen chloride or chlorine occurs in a heated reactor.

Embodiment 18 is the method of any one of embodiments 1-17, wherein a D/G ratio of the solid product as measured by Raman spectroscopy is between 0.05 and 0.5.

Embodiment 19 is the method of any one of embodiments 1-18, wherein a D/G ratio of the material is in a range of 0.75 to 2.

Embodiment 20 is the method of any one of embodiments 1-19, wherein the solid product consists of or consists essentially of the ordered graphitic carbon.

Embodiment 21 is a lithium ion battery comprising an anode, wherein the anode comprises the ordered graphitic carbon of any one of embodiments 1-20.

Embodiment 22 is the lithium ion battery of embodiment 21, wherein a capacity of the ordered graphitic carbon is greater than 200 mAh/g.

Embodiment 23 is the lithium ion battery of embodiments 21 or 22, wherein a capacity fade of the ordered graphitic carbon is less than 10% over 100 cycles.

Although this disclosure contains a specific embodiment detail, this should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter has been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A method of producing ordered graphitic carbon, the method comprising:
contacting a material comprising disordered elemental carbon and a metal with chlorine gas, thereby yielding:
a gaseous product comprising a chloride of the metal; and
a solid product comprising ordered graphitic carbon.

2. The method of claim 1, wherein the material comprises particles of the metal encapsulated by the disordered elemental carbon.

3. The method of claim 1, wherein the material is coked metal-carbon material.

4. The method of claim 3, wherein the coked metal-carbon material is formed in a hydroprocessing reaction catalyzed by the metal.

5. The method of claim 3, wherein the coked metal-carbon material is formed during synthesis of carbon particles catalyzed by the metal.

6. The method of claim 5, wherein the coked metal-carbon material comprises particles having an average diameter in a range of about 100 nm to about 50 microns.

7. The method of claim 6, wherein the particles are in the form of a carbon aerosol.

8. The method of claim 6, wherein the particles comprise carbon nanotubes.

9. The method of claim 1, wherein the material comprises hydrocarbonaceous material.

10. The method of claim 1, wherein a temperature of the hydrogen chloride or chlorine gas and the material after contacting is greater than or equal to a boiling point of the metal chloride.

11. The method of claim 1, further comprising condensing the metal chloride by reducing a temperature of the metal chloride to a temperature lower than a boiling point of the metal chloride.

12. The method of claim 1, wherein a concentration of metal in the solid product is less than 1 wt %.

13. The method of claim 1, wherein the metal comprises nickel, iron, manganese, cobalt, zinc, vanadium, molybdenum, magnesium, aluminum, tungsten, or an alloy or compound thereof.

14. The method of claim 1, wherein the hydrogen chloride or chlorine is in the gaseous state.

15. The method of claim 14, wherein contacting the material with the hydrogen chloride or chlorine comprises flowing the hydrogen chloride or chlorine over the material or through the material.

16. The method of claim 1, wherein a temperature of the hydrogen chloride or chlorine is at least about 900° C.

17. The method of claim 1, wherein contacting the material with the hydrogen chloride or chlorine occurs in a heated reactor.

18. The method of claim 1, wherein a D/G ratio of the solid product as measured by Raman spectroscopy is between 0.05 and 0.5.

19. The method of claim 1, wherein a D/G ratio of the material is in a range of 0.75 to 2.

20. The method of claim 1, wherein the solid product consists of or consists essentially of the ordered graphitic carbon.

21. A lithium ion battery comprising an anode, wherein the anode comprises the ordered graphitic carbon of claim 1.

22. The lithium ion battery of claim 21, wherein a capacity of the ordered graphitic carbon is greater than 200 mAh/g.

23. The lithium ion battery of claim 21, wherein a capacity fade of the ordered graphitic carbon is less than 10% over 100 cycles.
